(19) United States
(12) Patent Application Publication
(10) Pub. No.: US 2012/0098802 A1
(43) Pub. Date: Apr. 26, 2012

(54) LOCATION DETECTION SYSTEM

(75) Inventor: Clive Douglas Woon Feather, Cambridge (GB)

(73) Assignee: CAMBRIDGE SILICON RADIO LIMITED, Cambridge (GB)

(21) Appl. No.: 13/279,456

(22) Filed: Oct. 24, 2011

(30) Foreign Application Priority Data
Oct. 25, 2010 (GB) 1017976.0

(51) Int. Cl. G09G 5/00

(52) U.S. Cl. 345/204

(57) ABSTRACT

A directional display system includes a directional display device for displaying first visual content in a first direction, wherein the first direction is variable; and a processing system configured to establish a wireless link with a first wireless device positioned with a viewer for the first visual content, determine the direction of the first wireless device relative to the display device utilising the wireless link, and control the display device such that the first direction is defined at least in part by the direction of the first wireless device.

### RELATED APPLICATION DATA

This application claims the benefit of UK application no. 1017976.0, filed on Oct. 25, 2010, the disclosure of which is incorporated herein by reference in its entirety.

### BACKGROUND

Apparatus and methods for location detection are disclosed, and in particular location detection for directing images from a display.

Some display systems allow the displayed image to be steered in a particular direction, such that it is only viewable from that direction. Such systems enable displays to be directed to particular viewers. Furthermore, different images may be displayed in different directions, enabling differing images to be directed to multiple viewers in different locations.

In order to direct an image to a person in a particular location, the location or at least direction of that person must be determined by the display system. Known methods of location utilise facial recognition algorithms to identify faces in an image captured by a camera viewing the scene facing the display. Such algorithms are very processing-power intensive to achieve good results. In order to correctly direct multiple images to multiple people it is also necessary to distinguish faces from one another. Such processes require even greater processing power.

There is therefore a requirement for an efficient location system to enable direction of images from a display.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

There is provided a directional display system, comprising a directional display device for displaying first visual content in a first direction, wherein the first direction is variable; and a processing system configured to establish a wireless link with a first wireless device positioned with a viewer for the first visual content, determine the direction of the first wireless device relative to the display device utilising the first wireless link, and control the display device such that the first direction is defined at least in part by the direction of the first wireless device.

A wireless link may be established between the processing system and the wireless device.

The wireless device may be an audio output device, and audio information is transmitted from the processing system to the wireless device.

The display device may also displays second visual content in a second direction, and the processing system is configured to establish a wireless link with a second wireless device positioned with a viewer for the second visual content, determine the direction of the second wireless device relative to the display device, and control the display device such that the second direction is defined at least in part by the direction of the second wireless device.

The processing system may be configured to adjust the first and/or second direction depending on the position of the respective wireless device on respective viewer.

The first and/or second wireless device may comprise two wireless devices, each wireless device establishing a communications link with the processing system, wherein each communications link is utilised to establish the first and/or second direction.

At least one of the wireless links may be a Bluetooth link.

The processing system may comprise a plurality of antennas, each connected to a single signal receive chain.

The processing system may be configured to establish a first further wireless link with the first wireless device, and wherein the first and first further wireless links are utilised to determine the direction of the first wireless device.

The processing system may be configured to establish a second further wireless link with the second wireless device, and wherein the second and second further wireless links are utilised to determine the direction of the second wireless device.

The wireless links may also be utilised to determine the distance between the display and the viewer.

There is also provided a method of controlling a directional display system, comprising the steps of establishing a first wireless link between a processing system associated with the display and a first wireless device positioned with a first viewer for the display; establishing the direction of the first wireless device relative to the display utilising the first wireless link; and directing first visual content displayed by the display for the first viewer in a direction based at least in part on the direction of the first wireless device.

The first wireless device may be an audio output device, and further comprising the step of transmitting audio information to the first wireless device for output to the user, wherein the audio information is related to the visual content displayed for the first viewer.

The method may further comprise the steps of establishing a second wireless link between the processing system and a second wireless device positioned with a second viewer for the display; establishing the direction of the second wireless device relative to the display utilising the second wireless link; and directing second visual content displayed by the display for the second viewer in a direction based at least in part on the direction of the second wireless device.

The direction of the first and/or second visual content may be adjusted depending on the position of the relative wireless device on the relative viewer.

The first and/or second wireless device may comprise two wireless devices, and further comprising the step of establishing a communications link between the processing system and each wireless device, wherein each communications link is utilised to establish the first and/or second direction.

At least one of the wireless links may be a Bluetooth link.

The processing system may comprise a plurality of antennas, each connected to a single signal receive chain.

The method may further comprise the step of establishing a first further wireless link between the processing system and the first wireless device, and wherein the first and first further wireless links are utilised to determine the direction of the first wireless device.

The method may further comprise the step of establishing a second further wireless link between the processing system and the second wireless device, and wherein the second and second further wireless links are utilised to determine the direction of the second wireless device.

The wireless links are also utilised to determine the distance between the display and the viewer.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows a schematic diagram of a directional display device and a viewer with a wireless device;

FIG. 2 shows a schematic diagram of a directional display device and two viewers with wireless devices;

FIG. 3 shows a schematic diagram of a directional display device and a viewer;

FIG. 4 shows a schematic diagram of a directional display device and viewers with wireless devices on one side;

FIG. 5 shows a schematic diagram of a directional display device and a viewer with two wireless devices; and

FIG. 6 shows a schematic diagram of an exemplary processing system.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

In conjunction with displaying an image it may also be required to transmit an audio signal to a viewer. That audio transmission may be achieved using a wireless transmission system between the display and a wireless device located at the viewer's location. For example, a Bluetooth® link with a Bluetooth® headset could be utilised.

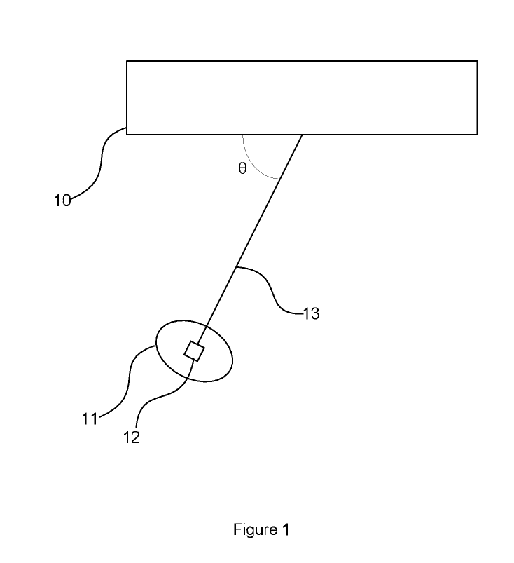

FIG. 1 shows a schematic diagram of a directional display 10 and a viewer 11 to who an image is being directed. The viewer 11 is utilising a wireless device 12 to receive audio via a wireless link 13. The display 10 may comprise a system for establishing the wireless link, or a separate communications system may be utilised.

The viewer 11 is located in a direction at an angle θ to the display, which is indicative of the angle at which the image should be directed such that it is viewed by the viewer. A direction finding function provided by the display 10 is configured to determine the angle θ, by calculating the angle of the wireless link 13 to the display 10. The display's system for establishing the wireless link 13 may not be positioned directly at the front of the display 10, for example the antenna(s) may be located behind the display 10. A geometric calculation may be utilised to account for any difference between the direction calculated for the wireless link 13 and the direction required for display of the image to the viewer. The direction finding function may be provided by a processing system as part of the display, or a separate processing system in combination, or separate from, the communications system.

Once the angle θ has been determined, the information is utilised by the display 10 to direct the image at the appropriate angle for viewing by the viewer 11 wearing the wireless device 12.

A conventional direction finding system with an array of antennas and receivers may be utilised, but such systems may be too expensive for widespread adoption due to the requirement for multiple receiver systems. U.S. patent application Ser. No. 12/558,019, published as US 2010/0075603, assigned to the applicant for this application, discloses a system and method for performing direction finding functions in a Bluetooth® system. That application is incorporated herein by reference and provides an example of an enabling method for the implementation of direction finding using Bluetooth® for the currently disclosed systems and methods. US 2010/0075603 discloses a system and method for determining direction of a Bluetooth® wireless link, without requiring a plurality of receiver chains, and may provide an economical way of implementing embodiments of the system and method. Similar methods may also be applied to other types of wireless link, as will be appreciated by the skilled person.

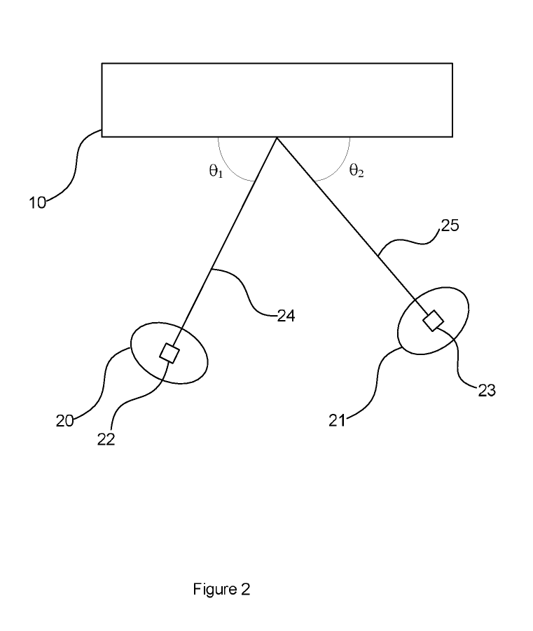

FIG. 2 shows the system of FIG. 1, but with two viewers 20 and 21. Each viewer has a wireless device 22, 23 for the reception of audio information as in the example of FIG. 1, but the image and audio information are different for each viewer and are related for each viewer. The process described above with reference to FIG. 1 is applied for each viewer independently to calculate the angle at which the image should be displayed. Each viewer can be identified by the identity of the wireless device 22, 23 they are wearing, which is ascertained via the wireless link 24, 25, and the display tracks the location of each wireless device 22, 23 and directs the appropriate image to each viewer. The audio information corresponding to each viewer 20, 21 is transmitted via the wireless link 24, 25, thereby enabling independent audio and visual information to be presented to each viewer 20, 21. As noted hereinbefore, distinguishing multiple viewers using facial recognition is particularly difficult. The use of wireless links for this identification provides a substantial simplification since each viewer can be reliably identified without requiring intensive image recognition processes. Since the image direction is determined based on the wireless link utilised to transmit the audio content, it is assured that the correct audio content is transmitted to the correct viewer.

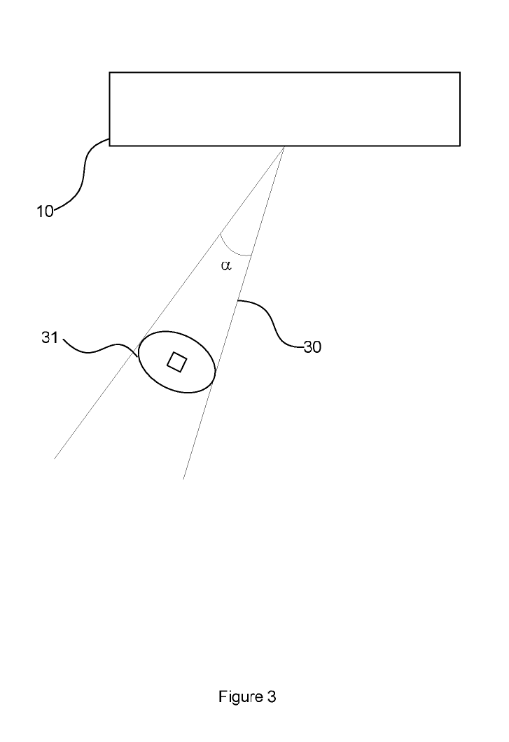

As shown in FIG. 3, the visual content 30 displayed by the device must be displayed over a finite angular width, α, such that the viewer's 31 eyes fall within the area covered by the visual content. As a viewer's distance to the display varies, the angular width α over which their content needs to be displayed also varies. That is, a larger angle α is required as the viewer gets closer to the screen to ensure their eyes fall within the image's projection. The wireless link may be utilised to estimate the distance, for example utilising the signal strength, and hence define the angular width, α, for the display. Minimising the angular width maximises the number of independent images that can be displayed without overlap between the images. An estimate of the width of the viewer's eyes, together with the distance between the display and the viewer allows the angle α to be calculated.

In an alternative embodiment two wireless links may be utilised between two different locations in the display device and a wireless device at the viewer. Triangulation and/or trilateration may then be utilised to determine the direction and the distance between the viewer and the display, and hence calculate values of α and θ. As will be appreciated more wireless links may also be utilised to provide further accuracy or measurements.

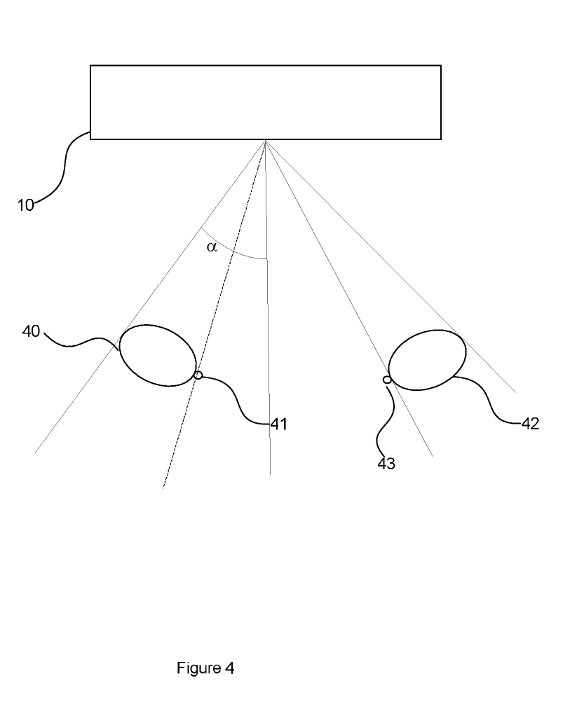

In the examples of FIGS. 1 and 2 it has been assumed that the wireless link is between the display and a receiver positioned centrally on the viewer, for example at the centre of a headband for headphones. FIG. 4 shows an example in which the viewer's 40 receiver 41 is located on one side of the viewer 40, for example in an earpiece. Since the system is not aware of the location of the receiver, the angular width α in FIG. 4 is double the width required to encompass the viewer. This ensures the viewer is within the projected image regardless of whether the receiver is on their left or right.

Viewer 42 also has a receiver 43 on one side, but in this example the system is aware of the side of the body on which the receiver 43 is positioned. The angular width of the display can thus be adjusted to encompass the viewer, without requiring a doubling of the width. A sensor may be provided in conjunction with the wireless device to determine its position on the viewer. For example, a sensor to detect orientation could provide an indication of left or right ear. Alternatively, the device may only be suitable for use in one location, for example one ear, and the location may be transmitted to the communications system. Furthermore, a configuration setting may be provided to indicate where the device is positioned.

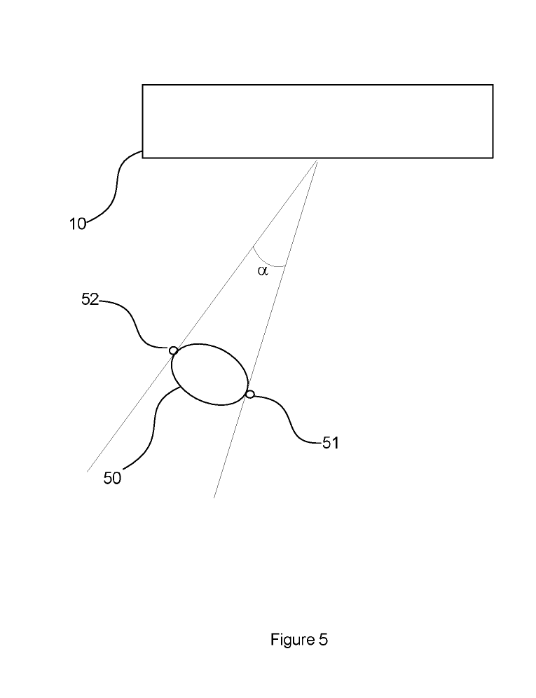

FIG. 5 shows an example in which a viewer 50 has two receivers 51, 52, one on each side, for example one in each of two earpieces. By calculating the direction of each of the receivers a more accurate estimate of the position and angular width of the displayed image can be made. This may be particularly important for the display of 3D images, where the 3D effect is achieved by displaying different images to each eye. In that case accurate knowledge of the centreline of the person is required to ensure the correct image reaches each eye. The system of FIG. 5 enables this as it can safely be assumed that the two receivers in the earpieces are located equidistant from the centreline.

The system may also be configured to display the same image to multiple viewers. For example, two viewers wishing to view the same visual content, may be located in a similar direction from the display, as determined by the direction of the wireless links. An average direction for the viewers may then be utilised with an image width suitable to encompass both viewers, such that they both view the same image. The same, or different (for example different translations), audio content may be transmitted to each viewer.

The above description has been provided with reference to a headset for communicating audio information to the viewer, but any form of wireless device positioned at the viewer may be utilised. For example, a device could be utilised solely for the purpose of providing the positioning system. As will be apparent, each viewer may utilise a different type of wireless device. Further specific examples include the wireless device being an audio input device, for example a microphone, to allow the viewer to transmit audio to the display or other local or remote viewers. For example, the display may be configured to operate as a virtual white-board allowing users to interact visually and audially.

The above description has given reference to the use of Bluetooth® wireless links, but any form of wireless link may be utilised. Similar processing techniques to those described for the Bluetooth® embodiment may be utilised for some other protocols, or other systems may be used as appropriate, as will be appreciated by the skilled person.

In the above description the direction considered has been the horizontal position of the viewer, but as will be appreciated the same principles may be applied to detecting location and directing images in the vertical direction, separately from, or in conjunction with, the horizontal direction.

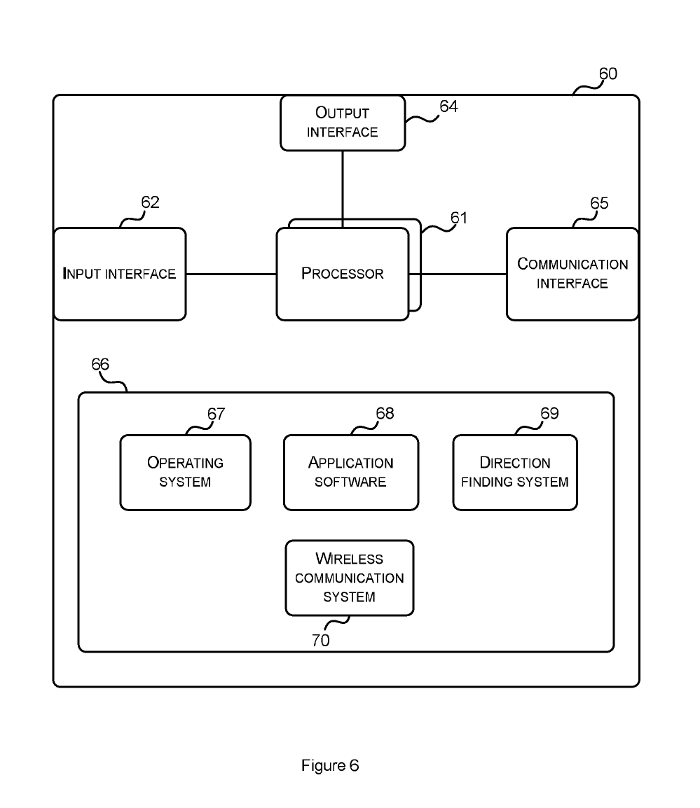

Reference is now made to FIG. 6 which illustrates various components of an exemplary processing system 60. Processing system 60 may be implemented as any form of a computing and/or electronic device in which direction finding and/or communications processes and systems may be implemented.

Processing system 60 comprises one or more processors 61 which may be microprocessors, controllers or any other suitable type of processor for processing computer executable instructions to control the operation of the device in order to implement the direction finding and/or communications processes.

The processing system 60 also comprises an input interface 62 arranged to receive and process input from one or more devices, such as the wireless communications devices shown in previous figures. The processing system 60 further comprises an output interface 64 arranged to output visual content, control, audio, and/or direction information to display device 10. Output interface 64 may also be configured to be bi-directional to allow transmission of information from the display device 10 to the processing system 60.

The processing system 60 also comprises a communication interface 65, which can be arranged to communicate with one or more communication networks. For example, the communication interface 65 can connect the processing system 60 to a network (e.g. the internet). The communication interface 65 can enable the processing system 60 to communicate with other network elements to store and retrieve data.

Computer-executable instructions and data storage can be provided using any computer-readable media that is accessible by processing system 60. Computer-readable media may include, for example, computer storage media such as memory 66 and communications media. Computer storage media, such as memory 66, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store information for access by a computing device. In contrast, communication media may embody computer readable instructions, data structures, program modules, or other data in a modulated data signal, such as a carrier wave, or other transport mechanism. Although the computer storage media (such as memory 66) is shown within the processing system 60 it will be appreciated that the storage may be distributed or located remotely and accessed via a network or other communication link (e.g. using communication interface 65).

Platform software comprising an operating system 67 or any other suitable platform software may be provided at the memory 66 of the processing system 60 to enable application software 68 to be executed on the device. The memory 66 can store executable instructions to implement the functionality of a direction finding 69 and/or wireless communications system 70, as described above, when executed on the processor 61.

The terms ‘computer’ or ‘processing system’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants, set-top boxes and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory etc and do not include propagated signals. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion, of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘image’ does not restrict the display to displaying static images, but encompasses any displayed visual content, including TV and computer displays etc.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

What is claimed is:

1. A directional display system, comprising
a directional display device for displaying first visual content in a first direction, wherein the first direction is variable; and
a processing system configured to:
establish a wireless link with a first wireless device positioned with a viewer for the first visual content,
determine the direction of the first wireless device relative to the display device utilising the first wireless link, and
control the display device such that the first direction is defined at least in part by the direction of the first wireless device.

2. A system according to claim 1, further comprising the wireless device, wherein a wireless link is established between the processing system and the wireless device.

3. A system according to claim 2, wherein the wireless device is an audio output device, and audio information is transmitted from the processing system to the wireless device.

4. A system according to claim 1, wherein the display device also displays second visual content in a second direction, and the processing system is configured to establish a wireless link with a second wireless device positioned with a viewer for the second visual content, determine the direction of the second wireless device relative to the display device, and control the display device such that the second direction is defined at least in part by the direction of the second wireless device.

5. A system according to claim 1, wherein the processing system is configured to adjust the first and/or second direction depending on the position of the respective wireless device on respective viewer.

6. A system according to claim 1 wherein the first and/or second wireless device comprises two wireless devices, each wireless device establishing a communications link with the processing system, wherein each communications link is utilised to establish the first and/or second direction.

7. A system according to claim 1 wherein at least one of the wireless links is a Bluetooth link.

8. A system according to claim 1 wherein the processing system comprises a plurality of antennas, each connected to a single signal receive chain.

9. A system according to claim 1 wherein the processing system is configured to establish a first further wireless link with the first wireless device, and wherein the first and first further wireless links are utilised to determine the direction of the first wireless device.

10. A system according to claim 1 wherein the processing system is configured to establish a second further wireless link with the second wireless device, and wherein the second and second further wireless links are utilised to determine the direction of the second wireless device.

11. A system according to claim 1 wherein the wireless links are also utilised to determine the distance between the display and the viewer.

12. A method of controlling a directional display system, comprising the steps of:
establishing a first wireless link between a processing system associated with the display and a first wireless device positioned with a first viewer for the display;
establishing the direction of the first wireless device relative to the display utilising the first wireless link; and
directing first visual content displayed by the display for the first viewer in a direction based at least in part on the direction of the first wireless device.

13. A method according to claim 12, wherein the first wireless device is an audio output device, and further comprising the step of transmitting audio information to the first wireless device for output to the user, wherein the audio information is related to the visual content displayed for the first viewer.

14. A method according to claim 12, further comprising the steps of:
establishing a second wireless link between the processing system and a second wireless device positioned with a second viewer for the display;
establishing the direction of the second wireless device relative to the display utilising the second wireless link; and
directing second visual content displayed by the display for the second viewer in a direction based at least in part on the direction of the second wireless device.

15. A method according to any of claims 12, wherein the direction of the first and/or second visual content is adjusted depending on the position of the relative wireless device on the relative viewer.

16. A method according to any of claims 12, wherein the first and/or second wireless device comprises two wireless devices, and further comprising the step of establishing a communications link between the processing system and each wireless device, wherein each communications link is utilised to establish the first and/or second direction.

17. A method according to any of claims 12, wherein the processing system comprises a plurality of antennas, each connected to a single signal receive chain.

18. A method according to any of claims 11 further comprising the step of establishing a first further wireless link between the processing system and the first wireless device, and wherein the first and first further wireless links are utilised to determine the direction of the first wireless device.

19. A method according to any of claims 11 further comprising the step of establishing a second further wireless link between the processing system and the second wireless device, and wherein the second and second further wireless links are utilised to determine the direction of the second wireless device.

20. A system according to any of claims 11 wherein the wireless links are also utilised to determine the distance between the display and the viewer.
